(19) United States
(12) Patent Application Publication
(10) Pub. No.: US 2019/0107191 A1
(43) Pub. Date: Apr. 11, 2019

(54) VEHICLE TRANSMISSION DEVICE

(71) Applicant: TOYOTA JIDOSHA KABUSHIKI KAISHA, Toyota-shi (JP)

(72) Inventor: Masashi OGAWA, Toyota-shi (JP)

(73) Assignee: TOYOTA JIDOSHA KABUSHIKI KAISHA, Toyota-shi (JP)

(21) Appl. No.: 16/151,769

(22) Filed: Oct. 4, 2018

(30) Foreign Application Priority Data
Oct. 10, 2017 (JP) 2017-197225

(51) Int. Cl. F16H 57/04; F16N 39/00; B01D 19/04

(52) U.S. Cl. CPC F16H 57/0409; B01D 19/04; F16N 39/002

(57) ABSTRACT

In a vehicle transmission device including an oil in a case, the case comprises a solid defoaming agent disposed therein, and the solid defoaming agent is disposed at a position at which the solid defoaming agent is at least partially located above the oil level of the oil during running of the vehicle.

This application claims priority from Japanese Patent Application No. 2017-197225 filed on Oct. 10, 2017, the disclosure of which is herein incorporated by reference in its entirety.

### BACKGROUND OF THE INVENTION

### Field of the Invention

The present invention relates to defoaming of oil provided in a case of a transmission device of a vehicle.

### Description of the Related Art

When oil provided in a case of a transmission device included in a vehicle is agitated by a gear etc., a foam is generated by mixing the oil with air. Foaming of the oil decreases the lubrication performance, so that when this oil is supplied to a gear or a bearing, the lubrication may be insufficient. In this regard, Patent Document 1 discloses that a particulate defoaming agent is added into oil for defoaming.

### CITATION LIST

Patent Document 1: Japanese Laid-Open Patent Publication No. 2014-62250

### SUMMARY OF THE INVENTION

### Technical Problem

In Patent Document 1, when the oil is rotated in a rotating body, the defoaming agent in the oil is centrifuged in the rotating body and adheres to an inner surface such as walls of the case, which reduces the density of the defoaming agent in the oil. As a result, the defoaming performance of the oil may decrease. In this regard, the viscosity of the oil can be increased to suppress generation of foam; however, as the viscosity of the oil becomes higher, a rotational resistance of gears and bearings is increased, so that fuel consumption deteriorates.

### SUMMARY OF THE INVENTION

The present invention was conceived in view of the situations and it is therefore an object of the present invention to provide a structure capable of suppressing decrease in defoaming performance of a defoaming agent defoaming a foam of oil provided in a transmission device.

### Solution to Problem

To achieve the above object, a first aspect of the present invention provides a vehicle transmission device (a) including an oil in a case, wherein (b) the case comprises a solid defoaming agent disposed therein, and (c) the solid defoaming agent is disposed at a position at which the solid defoaming agent is at least partially located above the oil level of the oil during running of the vehicle.

A second aspect of the present invention provides the vehicle transmission device recited in the first aspect of the invention, wherein a particulate defoaming agent is added into the oil.

A third aspect of the present invention provides the vehicle transmission device recited in the first or second aspect of the invention, wherein the transmission device is an automatic transmission.

A fourth aspect of the present invention provides the vehicle transmission device recited in any one of the first to third aspects of the invention, wherein the solid defoaming agent is gel.

A fifth aspect of the present invention provides the vehicle transmission device recited in any one of the first to fourth aspects of the invention, wherein the solid defoaming agent is fixed to at least one of an inner surface of the case, a wall surface of a breather chamber, and an inner surface of a catch tank.

### Advantageous Effects of Invention

According to the vehicle transmission device recited in the first aspect of the invention, at least a portion of the solid defoaming agent is disposed at a position located above the oil level of the oil during running of the vehicle, and therefore, when the generated foam moves upward from the oil level and adheres to the solid defoaming agent, the solid defoaming agent dissolves out and disperse inside the foam to be defoamed. Since the solid defoaming agent is not affected by centrifugal separation, the deterioration in defoaming performance is suppressed.

According to the vehicle transmission device recited in the second aspect of the invention, since the particulate defoaming agent is added into the oil, and the foam is defoamed by the particulate defoaming agent; however, when the oil is splashed, the particulate defoaming agent in the oil adheres to the wall due to centrifugal force, which reduces the density of the defoaming agent in the oil, so that the lubrication may become insufficient. In this regard, since the solid defoaming agent is further disposed, the generated foam is defoamed by the solid defoaming agent, so that deterioration in defoaming performance is suppressed.

According to the vehicle transmission device recited in the third aspect of the invention, since the transmission device is the automatic transmission, when the oil is splashed by the rotating members of the automatic transmission, the particulate defoaming agent in the oil is centrifuged and adheres to the inner surface of the case, which reduces the density of the defoaming agent in the oil. In this regard, by disposing the solid defoaming agent, the foam generated due to the reduction of the density of the defoaming agent is defoamed by the solid defoaming agent, so that deterioration in defoaming performance is suppressed.

According to the vehicle transmission device recited in the fourth aspect of the invention, the solid defoaming agent is gel. Therefore, the agent can easily be attached to the inner surface of the case etc.

According to the vehicle transmission device recited in the fifth aspect of the invention, the solid defoaming agent is fixed to at least one of the inner surface of the case, the wall surface of the breather chamber, and the inner surface of the catch tank. Therefore, when the generated foam adheres to the inner surface of the case, the wall surface of the breather chamber, or the inner surface of the catch tank, the defoaming agent fixed to these inner surfaces dissolves out and disperses within the foam, so that the foam is defoamed.

### BRIEF DESCRIPTION OF DRAWINGS

FIG. 1 is a simplified diagram of the inside of a transaxle included in a vehicle to which the present invention is applied.

FIG. 2 is a simplified cross-sectional view of an internal structure of a transaxle included in a vehicle that is another example of the present invention.

### DESCRIPTION OF THE PREFERRED EMBODIMENTS

In this embodiment, a defoaming agent is a silicone-based defoaming agent, for example.

Examples of the present invention will now be described in detail with reference to the drawings. In the following examples, the figures are simplified or deformed as appropriate, and portions are not necessarily precisely drawn in terms of dimension ratio, shape, etc.

### EXAMPLE 1

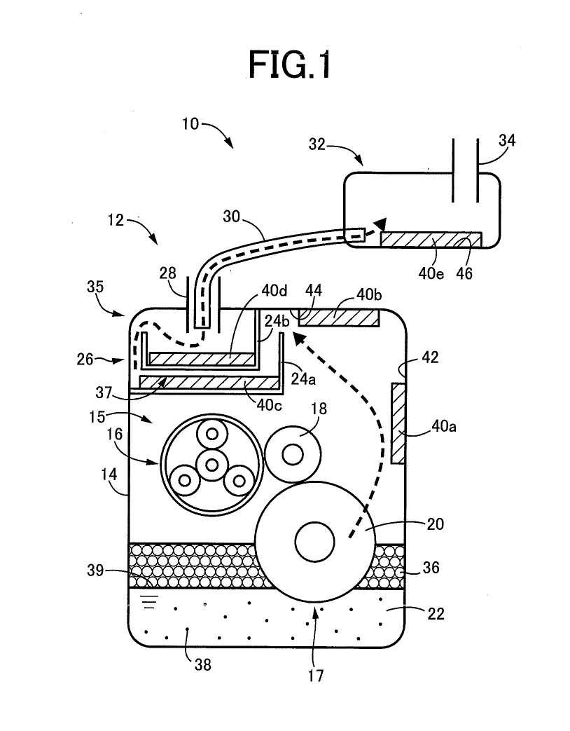

FIG. 1 is a simplified diagram of a structure of a transaxle 12 incldued in a vehicle 10 to which the present invention is applied. The upper side of the plane of FIG. 1 corresponds to the upper side of the vehicle 10, i.e., the upper side in the vertical direction. Hereinafter, the upper and lower sides refer to the upper and lower sides in the vertical direction, respectively. The transaxle 12 is disposed on a power transmission path not shown between an engine and drive wheels. The transaxle 12 is an FF-type (front-engine front-wheel drive) power transmission device including rotating devices such as an automatic transmission 15 and a differential device 17 in the same case 14. The automatic transmission 15 and the differential device 17 each correspond to a transmission device of the present invention.

The automatic transmission 15 is a planetary gear type multi-speed transmission configured to include multiple planetary gear devices 16 and multiple hydraulic friction engagement devices not shown inside the case 14 and shifted to multiple gear positions in accordance with switching of an engagement state of the hydraulic friction engagement devices. An output of the automatic transmission 15 is transmitted through a counter gear 18 etc. to the differential device 17. In FIG. 1, only the one planetary gear device 16 constituting the automatic transmission 15 is shown.

An oil 22 for lubricating the planetary gear device 16 etc. is supplied in the case 14, and a portion of a differential ring gear 20 constituting the differential device 17 is immersed in the oil 22 stored in a vertical lower portion of the case 14. Therefore, when the differential ring gear 20 rotates, the oil 22 is splashed up by the differential ring gear 20 and supplied to the planetary gear device 16, the counter gear 18, etc. The stored oil 22 is not only used as lubricating oil for gears etc., but also used as a hydraulic fluid for the hydraulic friction engagement devices not shown. The oil 22 supplied to the hydraulic friction engagement devices is pumped up by an oil pump not shown.

A labyrinth structure portion 26 provided with a ventilation path 37 described later is disposed on the upper side of the case 14, and a breather plug 28 is attached near an outlet port of the labyrinth structure portion 26 located on the upper side of the case 14. One end of a hose 30 is connected to the breather plug 28, and the other end of the hose 30 is connected to a catch tank 32. A ventilation port 34 is formed on the upper side of the catch tank 32, and the inside and the outside of the case 14 are ventilated through the ventilation port 34.

The labyrinth structure portion 26 is made up of a wall 24a bent into an L shape in cross section and a wall 24b bent in a U shape in cross section and has the bent ventilation path 37 formed between these walls 24a, 24b and an inner surface of the case 14. Since the ventilation path 37 is formed in a bent manner, the distance of the ventilation path 37 is made longer from an inlet port to the outlet port of the labyrinth structure portion 26. The ventilation path 37 formed in the labyrinth structure portion 26 functions as a breather chamber of a breather device 35 described later.

The breather device 35 is made up of the breather plug 28 and the ventilation path 37. The breather device 35 is provided for reducing a pressure difference between the inside and the outside of the case 14 and allows communication between the inside and the outside of the case 14. Since the ventilation path 37 functioning as the breather chamber is formed in a bent manner, the oil 22 adheres to an inner surface of the ventilation path 37 before the oil 22 reaches the breather plug 28. This prevents the oil 22 from being discharged from the breather plug 28.

In this example, the oil 22 with low viscosity is used. In this connection, for example, when being splashed up by the differential ring gear 20, the oil 22 is agitated so that the oil 22 and the air are mixed, and a foam 36 of the oil 22 is easily generated. As the foam 36 increases, the foam 36 moves upward from an oil level 39 and enters the ventilation path 37 constituting the labyrinth structure portion 26. The oil 22 entering the ventilation path 37 mostly remains in the ventilation path 37; however, as an amount of the foam 36 increases, a portion thereof reaches the breather plug 28. The foam 36 reaching the breather plug 28 reaches the catch tank 32 from the breather plug 28 through the hose 30. Although the foam 36 having reached the catch tank 32 is stored in the catch tank 32, a portion thereof may be discharged from the ventilation port 34 depending on the amount of the foam 36.

In this regard, a particulate defoaming agent 38 having particle shape is added into the oil 22 of this example. The particulate defoaming agent 38 enters a foam film of the foam 36 and locally reduces the thickness of the foam film to destroy the foam film for defoaming. In this way, the particulate defoaming agent 38 is dispersed in the oil 22, so that the foam 36 generated due to agitation of the oil 22 is defoamed by the particulate defoaming agent 38.

However, since the oil 22 of this example is also used as the hydraulic fluid for the hydraulic friction engagement devices, when the oil 22 is splashed together with rotating members constituting the hydraulic friction engagement devices, the particulate defoaming agent 38 is centrifuged by centrifugal force and adheres to walls of the rotating members. The particulate defoaming agent 38 is composed of a silicone-based defoaming agent etc. having a density higher than the oil 22 and is therefore easily centrifuged. Additionally, the particulate defoaming agent 38 is weak against heat and is easily degraded when the oil 22 becomes high in temperature. The particulate defoaming agent 38 is also degraded due to compression under high stress at a meshing portion of gears etc. Furthermore, when the oil 22 stored in the vertical lower portion of the case 14 is supplied to the hydraulic friction engagement devices, the oil 22 is pumped up by the oil pump, and since the oil 22 passes through a strainer in this case, the particulate defoaming agent 38 in the oil 22 is caught by the strainer. As described above, the particulate defoaming agent 38 dispersing in the oil 22 decreases as an operating time of the particulate defoaming agent 38 becomes longer, which makes the density of the particulate defoaming agent 38 in the oil 22 lower, so that the defoaming performance tends to deteriorate.

Therefore, in this example, solid defoaming agents 40a to 40e (described as a solid defoaming agent 40 if not particularly distinguished) shown in FIG. 1 are disposed in the case 14 separately from the inside of the oil 22. Specifically, the solid defoaming agent 40a is fixed to an inner wall surface 42 extending in the vertical direction of the case 14, the solid defoaming agent 40b is fixed to an inner upper surface 44 located in the vertically upper portion of the case 14, and the solid defoaming agents 40c, 40d are respectively fixed to surfaces of the walls 24a, 24b of the labyrinth structure portion 26. The solid defoaming agent 40e is fixed to an inner lower surface 46 located at a bottom of the catch tank 32. The solid defoaming agent 40 is all formed as a gel state so as to dissolve out when the foam 36 adheres to a surface of the solid defoaming agent 40, and is affixed by an adhesive etc. When the foam 36 adheres to the surface of the solid defoaming agent 40, particles gradually dissolve out from the solid defoaming agent 40, enter the foam 36, and destroy the foam film of the foam 36 for defoaming.

Each of the solid defoaming agents 40a to 40e is all disposed at a position located above the oil level 39 of the oil 22 during running of the vehicle 10. The oil level 39 of the oil 22 during running of the vehicle 10 corresponds to a maximum value of the height of the oil level 39 (maximum oil level) which changes depending on vehicle running conditions, such as, uphill and downhill roads, acceleration and deceleration, oil temperature of the oil 22, etc. Therefore, during running of the vehicle 10, the solid defoaming agent 40 is prevented from being immersed in the oil 22. Additionally, the solid defoaming agent 40 is disposed on a path through which the foam 36 passes when the foam 36 increases and moves upward from the oil level 39.

Since the solid defoaming agent 40 is at positions separated from the inside of the oil 22 as described above, when the foam 36 increases and moves upward from the oil level 39 and the foam 36 adheres to the surface of the solid defoaming agent 40, the particles dissolve out from the solid defoaming agent 40 and enter the foam 36, so that the foam 36 are defoamed. Since the solid defoaming agent 40 dissolves out only when the foam 36 adheres to the surface of the solid defoaming agent 40, the consumption of the solid defoaming agent 40 is reduced. Additionally, since the solid defoaming agent 40 is disposed on the path of the foam 36 reaching the breather plug 28, the foam 36 is efficiently defoamed by the solid defoaming agent 40 before the foam 36 reaches the breather plug 28.

Specifically, when the oil 22 stored in the case 14 is agitated, the foam 36 increases, moves upward from the oil level 39 as indicated by a broken line arrow of FIG. 1. Then, the foam 36 adheres to the fixed solid defoaming agent 40a fixed on the inner wall surface 42 of the case 14 and is defoamed by the solid defoaming agent 40a. The foam 36 which moves upward without adhering the solid defoaming agent 40a adheres to the solid defoaming agent 40b fixed on the inner upper surface 44 of the case 14, so that the foam 36 is defoamed by the solid defoaming agent 40b. The foam 36 having entered the ventilation path 37 of the labyrinth structure portion 26 moves as indicated by a broken line arrow of FIG. 1 and is defoamed when adhering to the solid foaming agents 40c, 40d fixed to the walls 24a, 24b forming the ventilation path 37. Furthermore, the foam 36 from out of the breather plug 28 and having reached the catch tank 32 is defoamed by the solid defoaming agent 40e fixed to the lower wall surface 46 of the catch tank 32. As described above, the foam 36 is sequentially defoamed by the respective solid defoaming agent 40 before the foam 36 reaches the catch tank 32, so that the discharge of the oil 22 from the ventilation port 34 of the catch tank 32 is suppressed.

Since the solid defoaming agent 40 is disposed above the oil level 39 of the oil 22 during running of the vehicle 10, the degradation due to heat of the oil 22 is suppressed. Furthermore, since the solid defoaming agent 40 is not affected by compression at the meshing portion of gears etc., the degradation due to compression is also suppressed.

Since no strainer is disposed on the path of the foam 36 reaching the catch tank 32, the particles of the dissolved solid defoaming agent 40 are not caught, so that the defoaming performance is not deteriorated. Furthermore, since the foam 36 is not rotated by the rotating members on the path to the catch tank 32, the dissolved solid defoaming agent 40 is not centrifuged. From the above, the solid defoaming agent 40 is hardly degraded as compared to the particulate defoaming agent 38, and the solid defoaming agent 40 dissolved into the foam 36 is neither centrifuged nor caught by the strainer, so that the deterioration in defoaming performance of the solid defoaming agent 40 is suppressed.

As described above, according to this example, the solid defoaming agent 40 is disposed at a position located above the oil level 39 of the oil 22 during running of the vehicle 10, and therefore, when the generated foam 36 moves upward from the oil level 39 and adheres to the solid defoaming agent 40, the particles in the solid defoaming agent 40 dissolve out and disperse inside the foam 36 to be defoamed. Since the solid defoaming agent 40 is not affected by centrifugal separation, the deterioration in defoaming performance is suppressed. Furthermore, the solid defoaming agent 40 is not degraded due to the heat of the oil 22 and is not affected by compression at the meshing portion of gears. Therefore, even the oil 22 with low viscosity can be used while suppressing the generation of foam 36.

According to this example, since the particulate defoaming agent 38 is added into the oil 22, and the foam 36 is defoamed by the particulate defoaming agent 38; however, when the oil 22 is splashed, the particulate defoaming agent 38 in the oil 22 adheres to the wall due to centrifugal force, which reduces the density of the defoaming agent in the oil 22, so that the lubrication may become insufficient. In this regard, since the solid defoaming agent 40 is further disposed, the generated foam 36 is defoamed by the solid defoaming agent 40, so that deterioration in defoaming performance is suppressed.

According to this example, since the power transmission device is the automatic transmission 15, when the oil 22 is splashed together with the rotating members of the automatic transmission 15, the particulate defoaming agent 38 in the oil 22 is centrifuged and adheres to the inner surface of the case 14, which reduces the density of the defoaming agent in the oil 22. In this regard, by disposing the solid defoaming agent 40, the generated foam 36 is defoamed by the solid defoaming agent 40, so that deterioration in defoaming performance is suppressed.

Another example of the present invention will be described. In the following description, portions common to the examples are denoted by the same reference numerals and will not be described.

### EXAMPLE 2

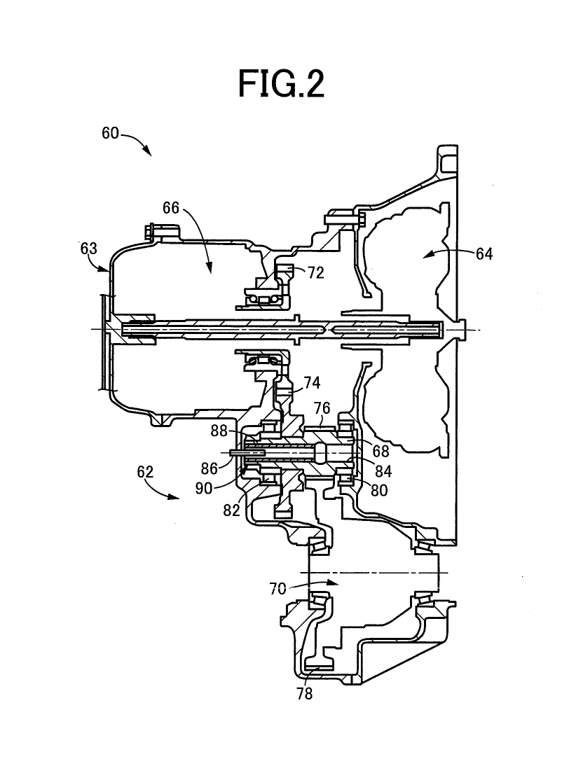

FIG. 2 is a simplified cross-sectional view of an internal structure of a transaxle 62 included in a vehicle 60 that is another example of the present invention. The transaxle 62 includes a torque converter 64, an automatic transmission 66, a counter shaft 68, and a differential device 70 which are housed in a case 63. Since the torque converter 64, the automatic transmission 66, and the differential device 70 are all well-known techniques, specific structures are not shown. The automatic transmission 66 and the differential device 70 both correspond to the transmission device of the present invention.

The automatic transmission 66 is coupled to the differential device 70 via the counter shaft 68 in a power transmittable manner. An output gear 72 of the automatic transmission 66 is meshed with a driven gear 74 disposed on the counter shaft 68, and a drive gear 76 disposed on the counter shaft 68 is meshed with a differential ring gear 78 of the differential device 70. Therefore, power output from the output gear 72 of the automatic transmission 66 is transmitted sequentially through the driven gear 74, the counter shaft 68, the drive gear 76, and the differential ring gear 78 to the differential device 70.

The counter shaft 68 is rotatably supported by a bearing 80 and a bearing 82. A shaft hole 84 which axially penetrates the counter shaft 68 is formed inside the counter shaft 68. The shaft hole 84 functions as a breather chamber constituting a breather device 90 of this example. A breather plug 86 is attached to the case 63. The breather plug 86 penetrates through a wall portion of the case 63 and is inserted from one opening of the shaft hole 84 of the counter shaft 68 into the shaft hole 84. The breather device 90 of this example is made up of the breather plug 86 and the shaft hole 84.

A gel-like solid defoaming agent 88 is fixed to an inner circumferential wall surface of the shaft hole 84 of the counter shaft 68. The solid defoaming agent 88 is formed into an elongated shape and is affixed parallel to an axial direction of the counter shaft 68. The solid defoaming agent 88 may be affixed at one position or more positions in a circumferential direction of the shaft hole 84 or may be affixed over the entire inner circumferential wall surface of the shaft hole 84. The position of the shaft hole 84 of the counter shaft 68 is set to be located above the oil level of the oil stored in the case 63 during running of the vehicle 60. Therefore, the solid defoaming agent 88 is disposed at a position not immersed in oil during running of the vehicle 60. In this way, the solid defoaming agent 88 is located to be separated from the oil also in this example.

Even when the solid defoaming agent 88 is disposed in the shaft hole 84 of the counter shaft 68 as described above, the same effects as the example described above can be obtained. Specifically, when a foam of the oil increases in the case 63 and reaches the inside of the shaft hole 84 of the counter shaft 68, the foam adhering to the solid defoaming agent 88 causes particles of the solid defoaming agent 88 to dissolve out into the foam, and the particles disperse inside the foam so that the foam is defoamed. Since the foam is defoamed by the solid defoaming agent 88 in this way, the discharge of the oil from the breather plug 86 is suppressed. As in the example described above, the solid defoaming agent 88 is not degraded due to heat of the oil and compression by gears, and the defoaming agent in the oil is prevented from decreasing due to centrifugal separation and due to being caught by the strainer, the deterioration in defoaming performance is suppressed. Therefore, according to this example, the same effects as the example described above can be obtained.

Although the examples of the present invention have been described in detail with reference to the drawings, the present invention is also applicable in other forms.

For example, although the particulate defoaming agent 38 is added into the oil 22 in the example, the particulate defoaming agent 38 is not necessarily required. Therefore, even if only the solid defoaming agent 40 is disposed, the foam 36 is defoamed by the solid defoaming agent 40, and the effects of the present invention can be obtained.

Although the solid defoaming agent 40 is disposed in the multi-speed automatic transmission 15 in the example, the present invention is not necessarily limited to the multi-speed automatic transmission 15. For example, the present invention is applicable to a belt-type continuously variable transmission. In the belt-type continuously variable transmission, the defoaming performance may be deteriorated since the particulate defoaming agent 38 in the oil is centrifuged by rotation of a pulley; however, the deterioration in defoaming performance is suppressed by disposing the solid defoaming agent 40. Therefore, the present invention is suitably used in a transmission device having a mechanism in which oil is splashed by a rotating member.

Although the solid defoaming agent 40 is all located above the oil level 39 of the oil 22 during running of the vehicle 10, 60 in the example, the solid defoaming agent 40 may not all be located above the oil level 39. For example, a portion of the solid defoaming agent 40 may be immersed in the oil 22 during running of the vehicle 10, 60. Therefore, the effects of the present invention can be obtained as long as at least a portion of the solid defoaming agent 40 is located above the oil level 39 of the oil 22 during running of the vehicle 10, 60.

The solid defoaming agents 40, 88 are both formed as a gel state in the examples; however, for example, a particulate defoaming agent may be solidified and molded into a solid form by a pressing machine, and the solid defoaming agent is not particularly limited as long as the agent is molded into a solid form.

In the example, the solid defoaming agent 40 is disposed on the inner wall surface 42 of the case 14, the inner upper surface 44 of the case 14, the walls 24a, 24b of the labyrinth structure portion 26, and the inner lower surface 46 of the catch tank 32; however, the present invention is not necessarily limited thereto. For example, the solid defoaming agent 40 may be disposed at any one of these surfaces. Additionally, the present invention is not limited to these surfaces, and the solid defoaming agent 40 may be disposed on an inner wall of the hose 30, for example. In short, if the solid defoaming agent 40 is disposed on the path of the foam 36 when the foam 36 increases, the effects of the present invention can effectively be obtained.

Although the catch tank 32 is disposed outside the case 14 in the example, the catch tank 32 may be disposed inside the case 14.

The above description is merely an embodiment and the present invention can be implemented in variously modified and improved forms based on the knowledge of those skilled in the art.

### REFERENCE SIGNS LIST

10, 60: Vehicle

15, 66: Automatic transmission (Transmission device)

14, 63: Case

24a, 24b : Wall (Wall surface)

28, 86: Breather plug

32: Catch tank

37: Ventilation path (Breather chamber)

38: Particulate defoaming agent

39: Oil level

40, 88: Solid defoaming agent

84: Shaft hole (Breather chamber)

What is claimed is:

1. A vehicle transmission device including an oil in a case, wherein
the case comprises a solid defoaming agent disposed therein, and
the solid defoaming agent is disposed at a position at which the solid defoaming agent is at least partially located above the oil level of the oil during running of the vehicle.

2. The vehicle transmission device according to claim 1, wherein a particulate defoaming agent is added into the oil.

3. The vehicle transmission device according to claim 1, wherein the transmission device is an automatic transmission.

4. The vehicle transmission device according to claim 2, wherein the transmission device is an automatic transmission.

5. The vehicle transmission device according to claim 1, wherein the solid defoaming agent is gel.

6. The vehicle transmission device according to claim 2, wherein the solid defoaming agent is gel.

7. The vehicle transmission device according to claim 3, wherein the solid defoaming agent is gel.

8. The vehicle transmission device according to claim 4, wherein the solid defoaming agent is gel.

9. The vehicle transmission device according to claim 1, wherein the solid defoaming agent is fixed to at least one of an inner surface of the case, a wall surface of a breather chamber, and an inner surface of a catch tank.

10. The vehicle transmission device according to claim 2, wherein the solid defoaming agent is fixed to at least one of an inner surface of the case, a wall surface of a breather chamber, and an inner surface of a catch tank.

11. The vehicle transmission device according to claim 3, wherein the solid defoaming agent is fixed to at least one of an inner surface of the case, a wall surface of a breather chamber, and an inner surface of a catch tank.

12. The vehicle transmission device according to claim 4, wherein the solid defoaming agent is fixed to at least one of an inner surface of the case, a wall surface of a breather chamber, and an inner surface of a catch tank.

13. The vehicle transmission device according to claim 5, wherein the solid defoaming agent is fixed to at least one of an inner surface of the case, a wall surface of a breather chamber, and an inner surface of a catch tank.

14. The vehicle transmission device according to claim 6, wherein the solid defoaming agent is fixed to at least one of an inner surface of the case, a wall surface of a breather chamber, and an inner surface of a catch tank.

15. The vehicle transmission device according to claim 7, wherein the solid defoaming agent is fixed to at least one of an inner surface of the case, a wall surface of a breather chamber, and an inner surface of a catch tank.

16. The vehicle transmission device according to claim 8, wherein the solid defoaming agent is fixed to at least one of an inner surface of the case, a wall surface of a breather chamber, and an inner surface of a catch tank.
